(19) United States
(12) Patent Application Publication
(10) Pub. No.: US 2024/0375614 A1
(43) Pub. Date: Nov. 14, 2024

(54) WIPER BLADE

(71) Applicant: Robert Bosch GmbH, Stuttgart (DE)

(72) Inventors: Helmut Depondt, Boutersem (BE); Steven Renckens, Hechtel-Eksel (BE)

(21) Appl. No.: 18/691,171

(22) PCT Filed: Sep. 30, 2022
(86) PCT No.: PCT/EP2022/077289

§ 371 Date: Mar. 12, 2024

(30) Foreign Application Priority Data
Sep. 30, 2021 (DE) 10 2021 211 023.1

(51) Int. Cl. B60S 1/42; B60S 1/38

(52) U.S. Cl. CPC B60S 1/42; B60S 2001/3812

(57) ABSTRACT

The invention relates to a wiper blade (14), in particular a wiper blade (14) for a motor vehicle, comprising a wiper strip (18) and a fastening element (16) for fastening the wiper strip (18) to a wiper arm (12) comprising at least a first adapter element (120), wherein a first adapter element (120) has a first guide surface (140, 142) and a second guide surface (140, 142) for longitudinally guiding the wiper arm (12), the first guide surface (140, 142) and the second guide surface (140, 142) being located on respective opposite outer faces of the fastening element (16). According to the invention, the first guide surface (140, 142) is in the form of a substantially rigid positioning element (141), and the second guide surface (140, 142) is in the form of a resilient coupling element (143).

### BACKGROUND

The invention relates to a wiper blade, in particular for a motor vehicle, and to a windshield wiper arrangement.

Numerous wiper blades are already known which have a wiper strip and a fastening element for fastening the wiper strip to a wiper arm. As a rule, several fastening elements are enclosed in the sales packaging here, so that the fastening element suitable for the respective wiper arm can be selected and fastened to the wiper strip. This is cumbersome and error-prone during mounting. Furthermore, fastening elements for hook-shaped ends of wiper arms are known, for example from DE 199 41 499 A1, which have flexible flaps to achieve an auto-adaptive characteristic.

### SUMMARY

The wiper blade according to the invention has the advantage that a robust fastening element is presented by a fastening element with at least one wall displaceable between two parallel end positions, which ensures a secure hold of the wiper strip on the wiper arm.

A fastening element is to be understood in particular as an adapter element that has a contact area to the wiper blade or to a wiper blade component and can be connected to the wiper blade or the wiper blade component, advantageously can be firmly connected, in particular can be connected in such a way that the wiper blade in the state connected to the fastening element is largely not displaceable relative to the fastening element. Advantageously, the wiper blade has an adapter part which is intended to couple with the fastening element. Advantageously, the fastening element is formed in one piece. In this context, the term “one-piece” should be understood to mean, in particular, surface-to-surface bonded, such as by a welding process and/or an adhesive process, etc., and, particularly advantageously, integrally formed, such as by manufacture from a casting and/or by manufacture in a single-component or multi-component injection molding process.

A windshield wiper arrangement in which the wiper arm is configured to slide onto the fastening element, in particular along the wiper arm direction and/or largely along the wiper arm direction, is particularly advantageous. This enables a reliable connection with a low overall height. In this way, good aerodynamic properties of the windshield wiper arrangement can be ensured. By largely slidable along the direction of the wiper arm is to be understood slidable along a sliding direction, wherein the sliding direction encloses an angle with the wiper arm direction which deviates from 0° by no more than 8°, advantageously by no more than 5°, particularly advantageously by no more than 2°. A windshield wiper arrangement in which the wiper arm is configured to be pushed onto the base element is configured in such a way that the fastening element has a first and a second guide surface for guiding the wiper arm, the wiper arm being largely immovable with respect to the fastening element perpendicular to a sliding direction in a state in which it is pushed onto the fastening element via the guide surfaces.

In the context of the present invention, a guide surface can be understood as a housing outer wall of the fastening element, which is configured to guide the wiper arm, in particular the fastening section, in the mounted state and thus to restrict the movement of the wiper arm by at least one degree of freedom. Preferably, the guide surface forms an active surface pair with the wiper arm. Preferably, the wiper arm is in contact with the guide surface by means of the fastening section. Preferably, the respective surface normals extend substantially transverse to the longitudinal direction. Preferably, the guide surfaces are arranged substantially parallel to each other in the unmounted state. Preferably, the guide surfaces extend substantially in the longitudinal direction. A longitudinal direction shall preferably be understood as a direction which is arranged in the direction of a greatest longitudinal extension of the wiper blade. By transverse it is to be understood that a first axis encloses with a second axis an angle which deviates from 90° by no more than 8°, advantageously by no more than 5°, particularly advantageously by no more than 2°. By parallel it is to be understood that a first axis encloses an angle with a second axis which deviates from 0° by no more than 8°, advantageously by no more than 5°, particularly advantageously by no more than 2°.

In particularly advantageous variants, the fastening element has at least one locking spring on a cover surface and the wiper arm has a correlating opening, the locking spring being configured to be insertable into the opening in a form-fitting manner. This enables a particularly stable and reliable connection between the fastening element and the wiper arm. Preferably, the locking spring covers less than one third of the cover surface of the fastening element.

A longitudinal direction is to be understood as a direction which is arranged in the direction of a greatest longitudinal extension of the wiper blade. By transverse it is to be understood that a first axis encloses with a second axis an angle which deviates from 90° by no more than 8°, advantageously by no more than 5°, particularly advantageously by no more than 2°. By parallel it is to be understood that a first axis encloses an angle with a second axis which deviates from 0° by no more than 8°, advantageously by no more than 5°, particularly advantageously by no more than 2°.

### BRIEF DESCRIPTION OF THE DRAWINGS

The drawings show exemplary embodiments of the wiper blade and the windshield wiper arrangement and are explained in more detail in the following description. Shown are:

FIG. 1 shows a windshield wiper arrangement,

FIG. 2 a perspective view of an adapter element according to the invention.

### DETAILED DESCRIPTION

In the different design variants, the same parts are given the same reference numbers.

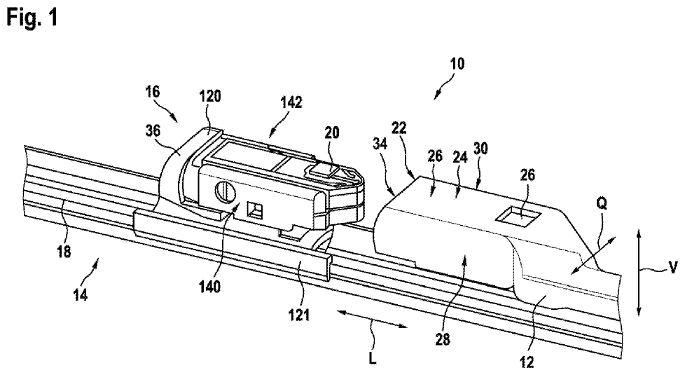

FIG. 1 shows a section of a perspective view of a windshield wiper arrangement 10. The windshield wiper arrangement 10 includes a wiper arm 12 and a wiper blade 14 connectable to the wiper arm 12. The wiper blade 14 has a wiper strip 18. In an installed state of the windshield wiper arrangement 10 in a vehicle, the wiper strip 18 may be pressed against a windshield of the vehicle and used to clean the windshield.

The wiper arm 12 is connected to the wiper blade 14 via a fastening element 16. According to the embodiment shown in FIG. 1, the fastening element 16 comprises a first adapter element 120 and one and a second adapter element 121. The wiper arm 12 can be slid over the end of the first adapter element 120 and locked onto it. The first adapter element 120 has a locking spring 20 for this purpose. The wiper arm 12 can be slid over the first adapter element 120 according to the so-called top-lock principle and locked by means of the locking spring 20. For this purpose, the wiper arm 12 is hollow at least at its ends so that the first adapter element 120 can project into an interior 22 of the wiper arm 12. Preferably, the wiper arm 12 has a fastening section 24. Preferably, the fastening section 24 of the wiper arm 12 includes at least one opening 26 into which the locking spring 20 can extend in a connected state of the wiper arm 12. Release of the wiper arm 12 can usually only be made possible after the locking spring 20 has been actuated or the locking spring 20 has been pushed through the at least one opening 26. Preferably, inserting and locking the wiper arm 12 to the first adapter element 120 may be performed in a wiper arm mounting position. In a wiper arm mounting position, the fastening element 16 is arranged relative to the wiper blade at a wiper arm mounting angle of, for example, 30°-45°. The wiper arm 12 may preferably be made of a metallic material and have, for example, a rectangular cross-section. The wiper strip 18 is preferably made of a resilient material and is used for cleaning windshields.

According to the embodiment of the invention shown in FIG. 1, the first adapter element 120 is attached to the wiper strip 18 in a pendulum-like manner. For this purpose, the wiper strip 18 has the second adapter element 121, on which the first adapter element 120 is rotatably mounted. According to a preferred embodiment of the invention, the first adapter element 120 can have a joint element, in particular a joint pin, which can form an active surface pair with a joint element of the second adapter element 121, in particular a guide means having in each case a first guide surface and a second guide surface. The first adapter element 120 and the second adapter element 121 may alternatively be mechanically connectable to each other without a rotational connection.

In the exemplary embodiment, a longitudinal extension direction L of the first adapter element 120 is arranged parallel to a longitudinal extension direction L of a wiper arm 12. According to the embodiment shown in FIG. 1, a longitudinal direction L of the wiper strip 18 is arranged substantially parallel to that of the wiper arm 12, in particular to the fastening section 24. In advantageous variants, the longitudinal extension direction L of the wiper blade 14 is arranged at least largely parallel to the wiper arm 12.

According to the embodiment of the invention shown in FIG. 1, the fastening section 24 of the wiper arm 12 has a substantially U-shaped contour with a cover surface 26 of a first side wall 28 and a second side wall 30. Preferably, the first side wall 28 and the second side wall 30 are arranged substantially parallel to each other. Preferably, the side walls 28, 30 are each formed as flat, thin-walled, substantially planar, in particular projection-free walls. Preferably, the cover surface 26 extends substantially perpendicular to the side walls 28, 30. The contour of the fastening section 24 of the wiper arm 12 is preferably dimensioned in such a way that the fastening section 24 with the respective side walls 28, 30 and the cover surface 26 lies flat against the first adapter element 120. The fastening section 24 of the wiper arm 12 includes a free end 34 that, when assembled, can abut a longitudinal stop 36 of the first adapter element 120.

The first adapter element 120 is substantially box-shaped and includes a base body 200 and two guide surfaces 140, 142. The first guide surface 140 and the second guide surface 142 are preferably arranged substantially parallel to each other and preferably each extend substantially in the longitudinal direction L. The first guide surface 140 and the second guide surface 142 are preferably arranged on respective opposite outer faces of the first adapter element 120. Preferably, guide surfaces 140, 142 are arranged substantially parallel to the side walls 28, 30. In a mounting end position, the guide surfaces 140, 142 each substantially at least partially, preferably completely, abut the side walls 28, 30 of the wiper arm 12.

The first guide surface 140 is formed as a substantially fixed positioning element. The positioning element does not have relative mobility with respect to the base body 200 of the first adapter element 120. The second guide surface 142 is arranged on the respective opposite housing side of the first adapter element 120 of the fastening element 16 and is formed as a resilient coupling element. The coupling element 140 is configured to be displaceable parallel and transversely with respect to the longitudinal direction L relative to the base body 200 of the first adapter element 120 of the fastening element 16. When an appropriate force is applied to the coupling element, the latter can be displaced from a rest position both in the longitudinal direction L and in the transverse direction Q relative to the base body 200.

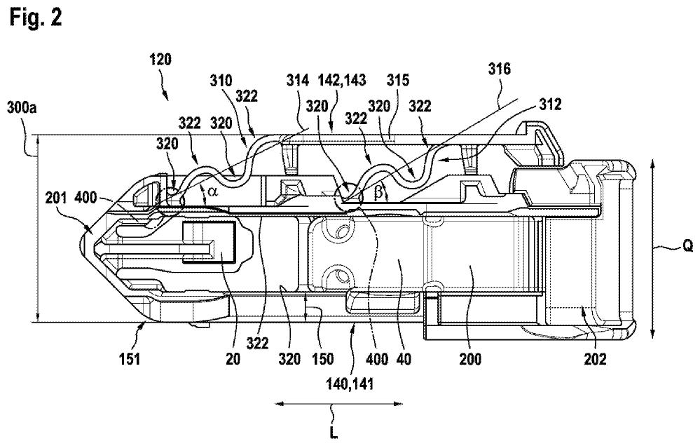

FIG. 2 shows an enlarged view of the first adapter element 120 of the fastening element 16 from below, that is, from the direction of the wiper strip 18. The first adapter element 120 includes a substantially rectangular base body 200. The base body 200 is formed with a substantially arrow-shaped tip at a first end 201. When the wiper arm 12 is mounted, it is slid on over the free end 201 of the first adapter element 120 of the fastening element 16. The first adapter element 120 has two opposing inner walls 320, 322, which in the assembled state lie flat against the second adapter element 121, in particular against corresponding outer surfaces of the second adapter element 121.

Opposite the first end 201, the first adapter element 120 has a second end 202 at which the longitudinal stop 36 is arranged. The inner walls 320, 322 are connected to each other on the side facing away from the wiper strip 18 via a substantially flat cover element 40. The inner walls 320, 322 and the cover element 40 form the substantially U-shaped base body 200 of the first adapter element 120 of the fastening element 16. The locking spring 20 is arranged in the area of the cover element 40, which is configured to be pressed in in the vertical direction V.

According to the embodiment of the invention shown in FIG. 2, the locking spring 20 is arranged in the region of the first end 201. The locking spring 20 is preferably formed as a tab fixed on one side. Preferably, the locking spring 20 is formed connected to the distal end of the first adapter element 120 of the fastening element 16. As can be clearly seen in FIG. 2, the first adapter element 120 has guide surfaces 140, 142 on its respective outer side surfaces.

As can be seen in FIG. 2, the first guide surface 140 is configured as a fixed positioning element 141. According to the preferred embodiment of the invention shown in FIG. 2, the positioning element 141 is formed as a housing wall of the base body 200. The positioning element 141 includes a relatively thick housing wall 150, such that the positioning element 141 provides a substantially fixed stop element in the transverse direction during mounting. The first guide surface 140 or the positioning element 141 extends substantially in the longitudinal direction L. The transition 151 between the positioning element 141 and the insertion slope of the free end 201 is preferably substantially rounded.

In addition to the first guide surface 140, the first adapter element 120 includes a second guide surface 142. The second guide surface 142 is formed as a resilient coupling element 143. The resilient coupling element 143 is configured to be displaceable in the longitudinal direction L and transversely to the longitudinal direction L. Due to the displaceability of the second guide surface 142, a distance 300a, 300b, 300c between the positioning element 141, in particular the outer housing wall of the positioning element 141 and the outer surface of the coupling element 143 is adjustable.

In order that the resilient coupling element 143 can be formed to be displaceable in the longitudinal direction L and transversely to the longitudinal direction in the transverse direction Q, the resilient coupling element 143 comprises at least one spring element 310, 312.

According to the embodiment of the invention shown in FIG. 2, the coupling element 143 comprises a first spring element 310 and a second spring element 312 as well as a side wall 315. The spring elements 310, 312 are preferably wave-like. The spring elements 310, 312 are preferably mechanically coupled to the base body 200. Preferably, the spring elements 310, 312 are configured as wave-shaped spring arms. Preferably, the spring elements 310, 312 describe a sinusoidal contour. Preferably, the wave-shaped spring elements 310, 312 each have two wave troughs 320 and two wave crests 322. In a preferred embodiment of the invention, the spring elements 310, 312 have at least three inflection points. Preferably, the spring elements 310, 312 are configured as filigree, thin-walled elements.

According to the embodiment of the invention shown in FIG. 2, the spring elements 310, 312 are arranged at a distance from each other in the longitudinal direction L. The first spring element 310 is the element facing the free end 201. The spring elements 310, 312 each have a main extension direction 314, 316.

FIG. 2 shows the first adapter element 120 in a resting position, that is, before being mounted to a wiper arm 12. In this rest position, the spring elements 310, 312 are compressed in the main extension direction 314, 316. The spring elements 310, 312 are connected to both the base body 200 and the side wall 315. The spring elements 310, 312 each have a first connection section 400 at the transition to the base body 200 and a second connection section 402 at the transition to the side wall 315. The side wall 315 is formed as a substantially planar element extending in a longitudinal direction. Preferably, the connection sections 400, 401 are each formed substantially at least partially free of jumps.

The main extension directions 314 of the first spring element 310 includes with the longitudinal direction L a first spring angle α. The main extension directions 316 of the second spring element 312 includes with the longitudinal direction L a second spring angle β. According to a preferred further development of the invention, the spring angle is in the range between 20° and 40°, preferably between 25° and 35°, particularly preferably at approximately 30°. A particularly preferred embodiment provides for the first spring angle α to be smaller than the second spring angle β.

The first adapter element 120 is shown in FIG. 2 in a rest position, that is, before the wiper arm 12 is slid over the adapter element 120. The adapter element 120 is now configured to be suitable for this purpose.

1. A wiper blade (14) comprising: a wiper strip (18) and a fastening element (16) for fastening the wiper strip (18) to a wiper arm (12), the fastening element (16) including at least a first adapter element (120) having a first guide surface (140, 142) and a second guide surface (140, 142) for longitudinally guiding the wiper arm (12), the first guide surface (140, 142) and the second guide surface (140, 142) being located on respective opposite outer faces of the fastening element (16), wherein the first guide surface (140, 142) is formed as a substantially fixed positioning element (141) and the second guide surface (140, 142) is formed as a resilient coupling element (143).

2. The wiper blade (14) according to claim 1, wherein the coupling element (143) is displaceable in a longitudinal direction (L) and transversely to the longitudinal direction (L), so that a distance (300a, 300b, 300c) transversely to the longitudinal direction (L) between the first guide surface (140) and the second guide surface (142) is adjustable.

3. The wiper blade (14) according to claim 1, wherein the coupling element (143) has a spring element (310, 312), the spring element (310, 312) being compressed in a main extension direction (314, 316).

4. The wiper blade (14) according to claim 3, wherein the main extension direction (314, 316) encloses with a longitudinal direction (L) a respective spring angle (α, β), the spring angle (α, β) being between 20° and 40°.

5. The wiper blade (14) according to claim 1, wherein the first adapter element (120) has at least a first mounting position and a second mounting position, wherein the coupling element (143) has a first distance from the positioning element in the first mounting position and a second distance from the positioning element in a second mounting position.

6. The wiper blade (14) according to claim 5, wherein characterized in that the adjustable difference between the first distance and the second distance is between 1 mm and 5 mm.

7. The wiper blade (14) according to claim 1, wherein the first adapter element (120) has a first stop surface and a second stop surface, the first stop surface and the second stop surface being formed offset parallel to one another, and the coupling element (143) having at least one support element for forming a guide support structure with a stop surface perpendicular to a longitudinal extension direction.

8. The wiper blade (14) according to claim 3, wherein the spring element (310, 312) is configured in such a such that a spring travel of the spring element (310, 312) corresponds at least to a length of a first stop surface of the first adapter element (120) when a mounting force of the wiper arm (12) is applied.

9. The wiper blade (14) according to claim 3, wherein the spring element (310, 312) comprises a force application section, the force application section being provided for transmitting the mounting force of the wiper arm (12), wherein the force application section is formed in a substantially arcuate shape.

10. The wiper blade (14) according to claim 1, wherein a first wall thickness of the positioning element (141) is between 150% and 400% of a second wall thickness of the coupling element (143).

11. The wiper blade (14) according to claim 7, wherein the second stop surface is arranged in a recess.

12. The wiper blade (14) according to claim 7, wherein the first stop surface is arranged on a projection.

13. A windshield wiper arrangement (10) comprising a wiper blade (14) and a wiper arm, wherein the wiper blade comprises a wiper strip and a fastening element for fastening the wiper strip to the wiper arm, wherein the fastening element comprises a first guide surface and a second guide surface for longitudinally guiding the wiper arm, wherein the first guide surface and the second guide surface are each arranged on respective opposite outer faces of the fastening element, wherein the first guide surface is formed as a substantially fixed positioning element and the second guide surface is formed as a resilient coupling element.

14. The windshield wiper arrangement according to claim 13, wherein the wiper arm comprises a fastening section configured to couple with the first and second guide surfaces of the fastening element of the wiper blade for fastening the wiper strip to the wiper arm.

15. The wiper blade (14) according to claim 3, wherein the spring element (310, 312) is wave-shaped.

16. The wiper blade (14) according to claim 4, wherein the spring angle (α, β) is between 25° and 35°.

17. The wiper blade (14) according to claim 16, wherein the spring angle (α, β) is 30°.

18. The wiper blade (14) according to claim 6, wherein the adjustable difference between the first distance and the second distance is between 2 mm and 4 mm.

19. The wiper blade (14) according to claim 18, wherein the adjustable difference between the first distance and the second distance is 3 mm.

20. The wiper blade (14) according to claim 10, wherein the first wall thickness of the positioning element (141) is between 200% and 350% of the second wall thickness of the coupling element (143).

21. The wiper blade (14) according to claim 20, wherein the first wall thickness of the positioning element (141) is between 250% and 300% of the second wall thickness of the coupling element (143).

22. The wiper blade (14) according to claim 11, wherein the recess is formed congruently with the support element.
